(19) United States
(12) Patent Application Publication
(10) Pub. No.: US 2014/0274189 A1
(43) Pub. Date: Sep. 18, 2014

(54) REDUCED-POWER TRANSMITTING FROM A COMMUNICATIONS DEVICE

(71) Applicant: MOTOROLA MOBILITY LLC, Libertyville, IL (US)

(72) Inventors: Paul J. Moller, Lake Zurich, IL (US); James J. Crnkovic, Hawthorn Woods, IL (US); Antonio Faraone, Fort Lauderdale, FL (US)

(73) Assignee: MOTOROLA MOBILITY LLC, Libertyville, IL (US)

(21) Appl. No.: 13/798,727

(22) Filed: Mar. 13, 2013

(51) Int. Cl. H04B 1/38; H04W 52/04

(52) U.S. Cl. CPC H04B 1/3838; H04W 52/04
USPC 455/522

(57) ABSTRACT

Aspects of the present disclosure teach decreasing, in a time-averaged regime, the amount of RF energy emitted by a communications device. Generally speaking, the network tells the communications device what power level it should transmit at. If, however, the device determines that it would exceed an emission standard by transmitting at the specified power level for as long as it needs to in order to carry out its transmission duties, then the device can instead decide to transmit at a lower power level. Alternatively (or in combination), the device can, instead of transmitting all the time while it has data to send, only transmit intermittently. In either case, the emitted electromagnetic energy, as averaged over a period of time, is reduced below the maximum allowed by the standard. Later, if possible and necessary, the device can again transmit at a higher power level or more frequently.

### CROSS-REFERENCE TO RELATED APPLICATIONS

The present application is related to U.S. patent application (Motorola Docket Number CS41454), filed on an even date herewith.

### TECHNICAL FIELD

The present disclosure is related generally to electronic communications and, more particularly, to transmitting radio-frequency energy.

### BACKGROUND

When they transmit, electronic devices necessarily produce and emit electromagnetic energy. If a device is near enough to a human being when it transmits (consider, for example, a cellular telephone), then some of that emitted energy can be absorbed by the human being.

Numerous health studies have failed to show any adverse health effects associated with the electromagnetic energy emitted by cellular telephones. However, some people are not convinced by these studies. The Federal Communications Commission (“FCC”) of the United States government sets precautionary standards that limit the amount of energy absorbable by a human being that a device can emit. These are the so-called Specific Absorption Rate (“SAR”) standards.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is an overview of a representative environment in which the present techniques may be practiced;

FIG. 2 is a generalized schematic of some of the devices of FIG. 1;

FIG. 3 is a flowchart of a representative method for decreasing transmit power;

FIG. 4 is a chart of a few representative transmit-power curves according to the teachings of the present disclosure;

FIG. 5 is a flowchart of a representative method for diminishing a transmission schedule; and

FIG. 6 is a chart of a few representative diminished transmission schedules according to the teachings of the present disclosure.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Communication devices such as cellular telephones, while originally designed to carry voice calls, are now capable of much more. Consider the communications environment 100 of FIG. 1. Here, a user 102 communicates via his personal communications device 104 (e.g., a cellular phone or tablet computer) to, for example, call a friend or access a web site 108. While performing these communications tasks, the device 104 emits RF energy. Further RF energy may be emitted if the device 104 acts as an intermediary. If, for example, the laptop computer 106 supports a short-range radio protocol, such as WiFi, but does not support cellular data, then the device 104 may support the device 106 by communicating over WiFi with the device 106 while simultaneously routing traffic from the device 106 over a cellular packet data link to the web site 108. In this case, the device 104 is seen to simultaneously support several different radio links and is emitting RF energy in support of each link. These and other communications tasks can increase the amount of RF energy emitted by the device 104 and can potentially increase the amount of RF energy to which the user 102 is exposed.

In another ongoing development, the FCC may change its SAR emission standards to be even more strict than they are currently.

Aspects of the present disclosure address these issues by decreasing, in a time-averaged regime, the amount of RF energy emitted by a communications device 104. Generally speaking, the network (also called the “source”) tells the communications device 104 what power level it should transmit at. If, however, the device 104 determines that it would exceed an emission standard by transmitting at the specified power level for as long as it needs to in order to carry out its transmission duties, then the device 104 can instead decide to transmit at a lower power level. Alternatively (or in combination), the device 104 can, instead of transmitting all the time while it has data to send, only transmit intermittently. In either case, the emitted electromagnetic energy, as averaged over a period of time, is reduced below the maximum allowed by the standard. Later, if possible and necessary, the device 104 can again transmit at a higher power level or more frequently.

FIG. 2 shows the major components of a representative electronics device 104, 106, 108. A portable communications device 104, 106 could be, for example, a smartphone, tablet, personal computer, electronic book, or gaming controller. The server 108 could be any of these and could also be a set-top box, a compute server, or a coordinated group of compute servers.

The CPU 200 of the electronics device 104, 106, 108 includes one or more processors (i.e., any of microprocessors, controllers, and the like) or a processor and memory system which processes computer-executable instructions to control the operation of the device 104, 106, 108. In particular, the CPU 200 supports aspects of the present disclosure as illustrated in FIGS. 3 and 5, discussed below. The device 104, 106, 108 can be implemented with a combination of software, hardware, firmware, and fixed-logic circuitry implemented in connection with processing and control circuits, generally identified at 202. Although not shown, the device 104, 106, 108 can include a system bus or data-transfer system that couples the various components within the device 104, 106, 108. A system bus can include any combination of different bus structures, such as a memory bus or memory controller, a peripheral bus, a universal serial bus, and a processor or local bus that utilizes any of a variety of bus architectures.

The electronics device 104, 106, 108 also includes one or more memory devices 204 that enable data storage, examples of which include random-access memory, non-volatile memory (e.g., read-only memory, flash memory, EPROM, and EEPROM), and a disk storage device. A disk storage device may be implemented as any type of magnetic or optical storage device, such as a hard disk drive, a solid-state drive, a recordable or rewriteable disc, any type of a digital versatile disc, and the like. The device 104, 106, 108 may also include a mass-storage media device.

The memory system 204 provides data-storage mechanisms to store device data 212, other types of information and data, and various device applications 210. An operating system 206 can be maintained as software instructions within the memory 204 and executed by the CPU 200. The device applications 210 may also include a device manager, such as any form of a control application or software application. The utilities 208 may include a signal-processing and control module, code that is native to a particular component of the electronics device 104, 106, 108, a hardware-abstraction layer for a particular component, and so on.

The electronics device 104, 106, 108 can also include an audio-processing system 214 that processes audio data and controls an audio system 216 (which may include, for example, speakers). A visual-processing system 218 processes graphics commands and visual data and controls a display system 220 that can include, for example, a display screen. The audio system 216 and the display system 220 may include any devices that process, display, or otherwise render audio, video, display, or image data. Display data and audio signals can be communicated to an audio component or to a display component via a radio-frequency link, S-video link, High-Definition Multimedia Interface, composite-video link, component-video link, Digital Video Interface, analog audio connection, or other similar communication link, represented by the media-data ports 222. In some implementations, the audio system 216 and the display system 220 are components external to the device 104, 106, 108. Alternatively (e.g., in a cellular telephone), these systems 216, 220 are integrated components of the device 104, 106, 108.

The electronics device 104, 106, 108 can include a communications interface which includes communication transceivers 224 that enable wired or wireless communication. Example transceivers 224 include Wireless Personal Area Network radios compliant with various IEEE 802.15 standards, Wireless Local Area Network radios compliant with any of the various IEEE 802.11 standards, Wireless Wide Area Network cellular radios, Wireless Metropolitan Area Network radios compliant with various IEEE 802.16 standards, and wired Local Area Network Ethernet transceivers.

The electronics device 104, 106, 108 may also include one or more data-input ports 226 via which any type of data, media content, or inputs can be received, such as user-selectable inputs (e.g., from a keyboard, from a touch-sensitive input screen, or from another user-input device), messages, music, television content, recorded video content, and any other type of audio, video, or image data received from any content or data source. The data-input ports 226 may include USB ports, coaxial-cable ports, and other serial or parallel connectors (including internal connectors) for flash memory, storage disks, and the like. These data-input ports 226 may be used to couple the device 104, 106, 108 to components, peripherals, or accessories such as microphones and cameras.

Finally, the electronics device 104, 106, 108 may include any number of “other sensors” 228. These sensors 228 can include, for example, accelerometers, a GPS receiver, compass, barometer, magnetic-field sensor, and the like.

FIG. 3 presents a representative method for decreasing the amount of RF energy emitted by the device 104 (and consequently decreasing the amount of RF energy potentially absorbed by the user 102). In this method, an “RFe” variable is set up that tracks emitted RF energy, even if only approximately or by “proxy.” In step 300, the RFe is increased whenever the device 104 transmits and thus emits RF energy. The amount of the increase is related to the amount of the energy transmitted. Because many devices 104 cannot actually measure their RF energy output, they instead base the RFe increase on their RF transmission-power level and on how long they transmit at that level. (This is a simplified integral of the RF transmission-power level over time.)

Step 302 decreases the RFe as time passes. Steps 300 and 302 reflect the processing of the RFe variable as a “leaky bucket.” Together, these steps 300, 302 set the RFe so that it reflects the total amount of RF energy emitted over a set period of time. For example, the SAR standard allows measurements to be averaged over a period of thirty minutes (for the FCC's so-called “uncontrolled” environment), so the RFe can be implemented to reflect the amount of RF energy emitted by the device 104 over the past thirty minutes. (For the FCC SAR's “controlled” environment and for some European SAR requirements, the period is six minutes.)

It is possible to continuously update the RFe. In more realistic embodiments, however, the RFe increase (step 300) is only performed when the device 104 transmits, while the RFe decrease (step 302) is only performed just before the RFe is used for step 306.

The accumulated RFe is compared against a threshold in step 306. (Optional step 304 is discussed below.) This threshold can be based, at least in part, on the SAR standard for the allowable amount of RF energy absorbed in a time-averaged window. Again, it should be noted that a typical device 104 actually uses the combination of the RF transmission-power level and the amount of time transmitting as a proxy for the RF energy absorbed. Laboratory testing of actual RF energy absorption during transmission can set conversion values, making this proxy calculation a sound one.

To be extra conservative, the threshold used in step 306 may be purposefully set somewhat below the maximum allowable by the SAR standard.

Other information, when available, can affect the threshold. Some devices 104 incorporate mechanisms (such as infrared sensors and generally part of the “other sensors” 228 of FIG. 2) that can determine whether the user 102 is closely proximate to the device 104. Because RF energy is highly dependent upon the distance between the emitting device 104 and the potential absorber 102, the threshold can be decreased if the user 102 is found to be very close to the device 104. Of course, this means that the threshold can vary constantly as the proximity changes. (Mathematically, it does not matter whether the threshold is decreased here or whether the RFe is increased even more in step 300. All such mathematical equivalencies are contemplated and are considered to be covered by the claims.)

Returning to step 304, some users 102 may be more concerned about RF energy absorption than others (even though, as discussed above, no reliable studies have shown any adverse health affects due to RF energy absorption, at the rates generated by cellular devices 104). Step 304 allows these users 102 to choose a “lower emissions” mode of operation for their device 104. This somewhat reduces the threshold used in step 306 and thus reduces the maximum capacity of the leaky bucket whose current fill level is measured by the RFe variable. The tradeoff for a reduced threshold is somewhat reduced throughput and possibly other noticeable call-quality issues.

If the accumulated RFe exceeds the threshold (step 308), then the RF transmission-power value is decreased in step 310. As a refinement in step 310, some embodiments predict future transmission requirements (possibly based on the amount of data to be sent soon as reflected in the amount of data currently in the transmit buffers, and possibly requiring the use of multiple RF protocols, e.g., simultaneously transmitting WiFi and cellular packet data) and base the amount of the decrease on these future requirements. In some situations, a good prediction leading to a greater decrease in power right now could avoid the necessity of drastically cutting power later.

There are many ways to decrease the RF transmission-power value, and FIG. 4 illustrates a few of them. The linear method shows the power value decreasing steadily over time, while the stepwise method takes the value down in discrete steps as needed (e.g., the size of the steps can be based on how much the RFe exceeds the threshold at any given time). The cyclic method tries to compromise while reducing the accumulation of RF energy transmitted by quickly alternating between periods of transmission at a relatively high power value (good for getting the data across without error) and periods of not transmitting at all (good for allowing the RFe to decrease over time).

In step 312, the device 104 transmits at the decreased RF transmission-power value. In consequence, the RFe increase (step 300) based on the transmission of step 312 is somewhat less than it would have been otherwise.

Note that, in some cases, the RF transmission-power level is set by a network commanding the device 104 to transmit at a given power level. In these cases, the device 104 “bends the rule” set down by the network by transmitting at the decreased RF transmission-power value.

There are many ways to perform the calculations of the method of FIG. 3. The following presents one representative method that uses the following definitions:
\hat{P} maximum RF transmission-power setting of the device 104
SÂR maximum (1 g or 10 g) SAR corresponding to the maximum transmission-power setting of the device 104
SAR_{L} applicable (1 g or 10 g) SAR limit
T allowable SAR-averaging time-interval
A time-interval at which the next allowable power setting is established (not smaller than the minimum interval between successive RF transmission-power adjustments)
tₕ generic (h-th) time when a power adjustment is made: tₕ=h·Δ
Pₕ RF transmission power setting during the interval [tₕ₋₁,tₕ)
N nearest integer not greater than T/Δ: N=└T/Δ┘

Assume that SÂR>SAR_{L} in an intended-use test configuration. For the SAR to be compliant at any time t, the following condition should be met:

$$\frac{1}{T} {\int }_{t - T}^{t} S A R ( τ ) d τ \leq S A {R}_{L} ⇒ \frac{1}{T} {\int }_{t - T}^{t} P ( τ ) d τ \leq \hat{P} \cdot ( \frac{S A {R}_{L}}{S \hat{A} R} ) = {P}_{L}$$

where SAR(τ) is the instantaneous (1 g or 10 g) SAR corresponding to the instantaneous RF transmission power P(r). SAR and RF transmission power are proportional.

At t=tₕ the SAR is compliant if:

$$\frac{1}{N + 1} {\sum }_{k = 0}^{N - 1} {P}_{h - k} + \frac{\hat{P}}{N + 1} \leq {P}_{L} ⇒ {\sum }_{k = 0}^{N - 1} {P}_{h - k} + \hat{P} \leq ( N + 1 ) {P}_{L} ⇒ {\sum }_{k = 0}^{N - 1} {P}_{h - k} \leq ( N + 1 ) {P}_{L} = \hat{P} = W$$

This is purposely made slightly conservative by assuming that P_{h-N}=\hat{P}, i.e., that the RF transmission-power setting during the prior (N+1)-th interval is equal to the maximum power of the device 104.

Question: Assuming that the SAR is compliant at t=tₕ, what is the maximum value allowable for the RF transmission power (Pₕ₊₁) at the next adjustment (t=tₕ₊₁)? The answer is:

$${\sum }_{k = 0}^{N - 1} {P}_{h + 1 - k} = {P}_{h + 1} + {\sum }_{k = 1}^{N - 1} {P}_{h + 1 - k} \leq W ⇒ {P}_{h + 1} \leq max \{ 0 , W - {\sum }_{k = 1}^{N - 1} {P}_{h + 1 - k} \} = {M}_{h + 1} .$$

Thus the RF transmission power will be set to no more than Mₕ₊₁ at the next adjustment. So if the network is requesting the device 104 to set its RF transmission-power level at Pₕ₊₁^{req}, the actual power setting will be:

Pₕ₊₁≦min {Pₕ₊₁^{req},Mₕ₊₁}.

Observe that:

Mₕ₊₁=W−Σₕ₊₁

where:

$$\begin{matrix}{Σ}_{h + 1} = {\sum }_{k = 1}^{N - 1} {P}_{h + 1 - k} \\ = {P}_{h} + {\sum }_{k = 2}^{N - 1} {P}_{h + 1 - k} \\ = {P}_{h} + \underbrace{{\sum }_{k = 1}^{N - 2} {P}_{h - k} + {P}_{h - ( N - 1 )}}_{{\sum }_{k = 1}^{N - 1} {P}_{h - k} = {Σ}_{h}} - {P}_{h - ( N - 1 )} \\ = {Σ}_{h} + [ {P}_{h} - {P}_{h - ( N - 1 )} ]\end{matrix}$$

thus showing that the computation of successive Σₕ coefficients (and the corresponding Mₕ power thresholds) can be done efficiently (two sums) without requiring the summation of N−1 terms at each iteration, which could be computationally cumbersome for a mobile processor especially when performed at every signal frame (e.g., 217 times per second for GSM, corresponding to about N=390,600 summation terms for T=thirty minutes).

This approach is very aggressive, in the sense that it forces the device 104 to transmit at the power level dictated by the network at all times until the “SAR allowance” is depleted (Mₕ₊₁ vanishes). At that point the device 104 stops transmitting (any call is dropped) and resumes only when Mₕ₊₁ becomes positive again.

On the pro side, such an approach does not produce any impact on the call quality (e.g., data rates) up to and until the “SAR allowance” is depleted. On the con side, it produces an abrupt termination of the call once Mₕ₊₁=0 (or below the lowest available power setting of the device 104).

Therefore, ancillary approaches could reduce the likelihood of dropped calls. For instance, it could be established that the power setting always be one “notch” (e.g., 2 dB) below what is currently requested by the system once the SAR allowance is, say, 50% depleted, then two notches when it is 75% depleted, and so on.

The “SAR depletion factor” can be defined as:

$$α = \frac{\frac{1}{T} {\int }_{t - T}^{t} S A R ( τ ) d τ}{S A {R}_{L}} = \frac{\frac{1}{T} {\int }_{t - T}^{t} P ( τ ) d τ}{{P}_{L}}$$

which can be implemented in a computationally efficient fashion as:

$${α}_{h + 1} = \frac{\frac{1}{N} {\sum }_{k = 0}^{N - 1} {P}_{h - k}}{{P}_{L}} = \frac{\frac{1}{N} ( {P}_{h} + {\sum }_{k = 1}^{N - 1} {P}_{h - k} )}{{P}_{L}} = \frac{{P}_{h} + {Σ}_{h}}{N \cdot {P}_{L}} .$$

The SAR depletion factor is used to “notch-down” the RF transmission power as long as Mₕ₊₁>\hat{P}, otherwise the power level would be reduced unnecessarily. This criterion can be changed to Mₕ₊₁>Pₕ₊₁^{req} to reduce the likelihood of abrupt dropped calls. However, in this case the transmit power would stay lower than the level that would be allowed by the former (Mₕ₊₁>\hat{P}) condition. Therefore, the choice of one of the two options may depend on the type of call, for instance the former option might be more suitable for a voice call.

FIG. 5 presents another representative method for decreasing the amount of RF energy emitted by the device 104. It may be used as an alternative to, or in conjunction with, the method of FIG. 3. The first steps, 300 through 308, can be the same as described above for FIG. 3. That is, the RFe is calculated and compared against a threshold.

If the RFe exceeds the threshold (step 308), then instead of (or in addition to) reducing the RF transmission power (see the discussion of step 310 of FIG. 3 above), the RF transmission schedule is diminished (step 500). That is, even if there are sufficient data waiting to be sent to justify sending in every available timeslot, transmission will be scheduled only for some of the timeslots. During the other timeslots, the device 104 does not transmit, thus allowing the leaky bucket RFe to decrease.

As there are many ways to decrease the RF transmission power (see FIG. 4 and the accompanying discussion), there are many ways to diminish the transmission schedule. In some cases, the schedule is decreased deterministically. Thus, for example, transmission is scheduled for only every other timeslot, or every third timeslot, etc. In other cases, the scheduling can be random, as illustrated by the transmission schedules of FIG. 6. In the bottom line of FIG. 6, transmissions are randomly scheduled for 50% of the timeslots. In the top line, the percentage of scheduled timeslots is dropped to only 6.25%. As with reducing RF transmission power, the actual amount of diminishing of the transmission schedule can depend on many factors such as the amount that the RFe exceeds the threshold, predicted future transmission requirements, and the like.

In step 502, data are transmitted according to the diminished schedule. One way to accomplish this is to withhold data from the transmitting modem until the diminished schedule allows further transmission. Other techniques may be appropriate for other devices 104, depending upon specifics of their implementation.

In view of the many possible embodiments to which the principles of the present discussion may be applied, it should be recognized that the embodiments described herein with respect to the drawing figures are meant to be illustrative only and should not be taken as limiting the scope of the claims Therefore, the techniques as described herein contemplate all such embodiments as may come within the scope of the following claims and equivalents thereof.

We claim:

1. A method for transmitting from a communications device, the method comprising:
increasing, by the communications device, an RFe (“Radio-Frequency emission”) variable, the increasing associated with the communications device transmitting RF energy;
decreasing, by the communications device, the RFe, the decreasing associated with a passage of time;
comparing, by the communications device, the RFe against a threshold; and
if the RFe exceeds the threshold, then:
decreasing, by the communications device, an RF transmission-power value; and
subsequently transmitting, by the communications device, at the decreased RF transmission-power value.

2. The method of claim 1 wherein an amount of the increasing is based, at least in part, on a calculated amount of RF energy transmitted by the communications device.

3. The method of claim 2 wherein the calculated amount of RF energy transmitted is based, at least in part, on an RF transmission-power value and an amount of transmission time.

4. The method of claim 1 wherein zero is a lower limit of the RFe.

5. The method of claim 1 wherein the decreasing is performed when the communications device has data to transmit.

6. The method of claim 1 wherein the threshold is based, at least in part, on a time-averaged RF transmission-power window.

7. The method of claim 6 wherein the threshold is based, at least in part, on a Federal Communications Commission Specific Absorption Rate standard.

8. The method of claim 1 wherein the threshold is based, at least in part, on a detected proximity of the communications device to a user of the communications device.

9. The method of claim 1 wherein the RF transmission-power value is based, at least in part, on information received by the communications device from a network device.

10. The method of claim 1 wherein an amount of the decrease of the RF transmission-power value is based, at least in part, on a difference between the RFe and the threshold.

11. The method of claim 1 further comprising:
receiving, from a user of the communications device, input;
wherein the threshold is based, at least in part, on the user input.

12. The method of claim 1 further comprising:
predicting future transmission requirements; and
decreasing the RF transmission-power value, the decreasing based, at least in part, on the predicted future transmission requirements.

13. A communications device configured for transmitting, the communications device comprising:
a communications interface; and
a processor operatively connected to the communications interface and configured for:
increasing an RFe (“Radio-Frequency emission”) variable, the increasing associated with the communications device transmitting RF energy;
decreasing the RFe, the decreasing associated with a passage of time;
comparing the RFe against a threshold; and
if the RFe exceeds the threshold, then:
decreasing an RF transmission-power value; and
subsequently transmitting, via the communications interface, at the decreased RF transmission-power value.

14. The communications device of claim 13 wherein the device is selected from the group consisting of: a personal communications device, a mobile telephone, a personal digital assistant, and a tablet computer.

15. The communications device of claim 13 wherein the communications interface comprises a plurality of transmitters.

16. The communications device of claim 13 further comprising:
a proximity detector operatively connected to the processor;
wherein the threshold is based, at least in part, on a detected proximity of the communications device to a user of the communications device.

17. The communications device of claim 13 further comprising:
a user interface operatively connected to the processor, the user interface configured for receiving input from a user of the communications device;
wherein the threshold is based, at least in part, on the user input.
